(19) United States
(12) Patent Application Publication
(10) Pub. No.: US 2022/0186744 A1
(43) Pub. Date: Jun. 16, 2022

(54) DIFFUSER SYSTEM AND CENTRIFUGAL COMPRESSOR COMPRISING THE SAME

(71) Applicant: Carrier Corporation, Palm Beach Gardens, FL (US)

(72) Inventors: Hang Zhao, Shanghai (CN); Vishnu M. Sishtla, Manlius, NY (US)

(21) Appl. No.: 17/059,029

(22) PCT Filed: Jun. 11, 2020
(86) PCT No.: PCT/US2020/037211

§ 371 Date: Nov. 25, 2020

(30) Foreign Application Priority Data
Jun. 19, 2019 (CN) 2019 10531258.7

(51) Int. Cl. F04D 29/44; F04D 17/10; F04D 29/02

(52) U.S. Cl. CPC F04D 29/441; F04D 29/023; F04D 17/10

(57) ABSTRACT

The present application discloses a diffuser system and a centrifugal compressor comprising the same. The diffuser system comprises: a passage through which a compressed gas is flowable; and a wall defining the passage, the wall comprising a movable part which is driven to enter the passage so as to change a flow area of the passage, wherein the movable part comprises an elastomer configured to expand to guide the flow of the compressed gas when at least a portion of the movable part enters the passage, and to retract when the movable part withdraws from the passage. The diffuser system involved in the present application re-orients a flow route of the compressed gas in the passage.

### CROSS REFERENCE TO RELATED APPLICATIONS

This application claims the benefit of CN Application No.: 201910531258.7, filed on Jun. 19, 2020, which is incorporated herein by reference in its entirety.

### TECHNICAL FIELD

The present application relates to the field of compressors. To be specific, the present application relates to a diffuser system for a compressor and a centrifugal compressor comprising the diffuser.

### BACKGROUND ART

Compressors are widely applied in industries. Fine compressors may provide an excellent fluid compression performance. In the field of refrigeration, compressors are an extraordinary crucial link in a refrigeration system. As one type of compressors, the centrifugal compressor can provide a high-efficient gas compression capability with a large capacity, which, thus, is employed in the field of commercial refrigeration far and wide. The centrifugal compressor comprises a diffuser which compressed gas passes through. In various work conditions, especially those with part-load operating, problems such as compressor surges and vibrations could easily occur at a flow channel of an invariable centrifugal compressor diffuser. In this background, a variety of structural designs would generally be employed to make the flow channel's width of the centrifugal compressor diffuser adjustable so as to relieve the surge problem of a centrifugal compressor and reduce its noise and vibrations. One problem of centrifugal compressors diffuser of this type is the performance loss with respect to pneumatics when the width of a flow channel is changed.

### SUMMARY

According to one aspect of the present application, a diffuser system is provided and comprises: a passage through which a compressed gas is flowable; a wall defining the passage, the wall comprising a movable part which is driven to enter the passage so as to change a flow area of the passage, wherein the movable part comprises an elastomer configured to expand to guide the flow of the compressed gas when at least a portion of the movable part enters the passage and to retract when the movable part withdraws from the passage.

The diffuser system involved in the present application re-orients a flow route of the compressed gas in the passage, especially the flow route of the compressed gas close to the movable part of the wall, so as to obtain a desired flow path of the compressed gas while changing the flow area of the diffuser, whereby a better pneumatic performance of the compressed gas is provided and the effect of boosting pressure is improved. After entering the passage, the elastomer deforms and guides the compressed gas passing through. In designs of the past, a movable part is driven to block the passage so as to regulate the section across which the compressed gas flows as well as the flow rate of the compressed gas. However, it is found that when the movable part enters the passage, the compressed gas will hit against the wall of the movable part such that the energy losses. Moreover, since a portion of the movable part lies within the passage, a step is formed between the movable part and the fixed part of the wall, which the compressed gas flow past forms a turbulent flow. For this reason, the flow route of the compressed gas in this manner is undesired. The setting of the elastomer can solve this problem. When entering the passage, the elastomer deforms. The compressed gas follows the deforming surface of the expanded elastomer and, thus, changes its flow route. The deforming shape of the expanded elastomer can be obtained by design. When the elastomer withdraws from the passage, it returns to the initial state due to recovery force and thus the diffuser at this moment opens the passage.

Further, the present application can use an existing drive system of a diffuser to deform the elastomer. In this manner, the present application saves the cost and facilitates the diffuser system involved in the present application. One should think of that the drive system may also be other mechanisms or the drive system can urge the elastomer to deform in any existing manners. The drive system can be a portion of the movable part of the wall, or separate from the movable part.

According to one embodiment of the diffuser system, the elastomer forms a streamline surface in the passage after expanding.

The compressed gas passes across the streamline surface. The design of the streamline surface, especially the part of the streamline surface facing the gas (i.e., facing the flow direction of the gas), will reduce the resistance against flow of the gas, such that a better pneumatic performance can be acquired. That is, the streamline surface can be formed only on the elastomer's deformed portion facing the gas, or can be formed on the elastomer's deformed portions facing and deviating from the gas respectively (the elastomer's deformed portion deviating from the gas means the elastomer's deformed portion facing the opposite direction of the flow of the gas), or on the entire deformed portion of the elastomer. The streamline can be shaped to be curved, round or smooth-line, which, for example, be shaped as a water drop with its two ends being consistent or inconsistent or an arc.

According to one embodiment of the diffuser system, the elastomer is a membrane element attached to the wall. Two ends of the membrane element extend and is bonded to the fixed part of the wall. The middle part of the membrane is driven to move towards the passage and deforms in the passage to be a bulging part. A fine transition is formed between the bulging part and the fixed part of the wall, whereby the compressed gas can pass smoothly. The membrane element can be mounted onto the wall by any known means.

According to one embodiment of the diffuser system, the membrane element is made of rubber material or metal material, or the membrane element comprises a core made of metal material and a wrap structure in which the core is contained, the wrap structure being made of rubber material. When the membrane element is made of rubber material, the rubber material can additionally have an elastic sheet adhering thereon or can be modified—for example, fibre reinforced materials may be employed, to increase the strength of the membrane element.

According to one embodiment of the diffuser system, the membrane element is made of hydrogenated nitrile butadiene rubber.

According to one embodiment of the diffuser system, the movable part of the wall further comprises a piston for pushing the elastomer, the piston being arranged within a groove which forms on the wall and is sealed by the elastomer; the elastomer, the wall and the piston are annular.

According to one embodiment of the diffuser system, the piston is of a pneumatic drive, or is a hydraulic drive such as oil hydraulic drive.

According to one embodiment of the diffuser system, the piston has a rigid head in contact with the elastomer, the head having a section shape with an arc surface. The piston pushes the elastomer into the passage, and the given shape of the piston's head helps the elastomer deform to a shape that the compressed gas can flow across along an ideal route. In the section, the arc surface can be either symmetrical or asymmetrical. The arc surface can be a curve with various radians (radii of curvature) which is formed by the whole surface of the head of the piston, a shape which has two ends of curves (i.e., a round chamfer) connected with a beeline. The two ends here are respectively a portion substantially facing a flow direction of the compressed gas and a portion deviating from a flow direction of the compressed gas—certainly, only the end facing the compressed gas can be a curve or the two ends can be both oblique lines (i.e., flat chamfer, e.g., chamfer with 45°), which are directly connected or transitionally (e.g., smoothly) connected by a beeline. Likewise, the two ends here are respectively a portion substantially facing a flow direction of the compressed gas and a portion deviating from a flow direction of the compressed gas—certainly, only the end facing the compressed gas can be an oblique line.

According to one embodiment of the diffuser system, a pressure balance hole is arranged at the bottom of the groove, the pressure balance hole being in communication with the passage. Since the pressure of the compressed gas in the passage is not low, the pressure in the passage close to the head of the piston is higher than that near the bottom of the groove. Thus, the configuration of the pressure balance hole balances the pressures on both sides of the piston such that the piston obtains an enough thrust force to push the elastomer into the passage and reduce the operating resistance of the drive system of the piston. The pressure balance hole can be arranged at both ends close to the piston, which means the end facing the compressed gas or the end deviating from the compressed gas.

The second aspect of the present application is to provide a centrifugal compressor, comprising: an impeller, a volute arranged on a radially outward side of the impeller, and the diffuser system according to any one of preceding embodiments, wherein the passage is positioned between the impeller and the volute.

The centrifugal compressor of the present application has an improved pressure boosting performance and an improved efficiency in operation.

With the following elaborations illustrated by figures, other aspects and features of the present application become evident. However, as shall be understood, the figures are intended only for the explanation rather than the definition of the scope of the present application because it shall refer to the additional claims. As shall be understood further, the figures are only for the purpose of conceptually explaining the structures and flows described here. Unless there are other indications, one shall not fabricate figures according to these examples.

### BRIEF DESCRIPTION OF FIGURES

Referring to the elaboration of following specific embodiments in combination with the figures, one could understand the present application more sufficiently. And, the identical reference signs in the figures invariably indicate the same elements illustrated by the figures. Details are as follows:

FIG. 1 is a sectional diagram of the centrifugal compressor in an operating state involved in the present application;

FIG. 2 is a sectional diagram of the centrifugal compressor in another operating state involved in the present application;

FIG. 3 is a partial enlargement of the involved diffuser system of the centrifugal compressor illustrated in FIG. 2;

FIG. 4 is a diagram shown from another angle of the diffuser system of the centrifugal compressor involved in the present application;

FIGS. 5A and 5B are sectional diagrams of the first embodiment of the piston in the diffuser system involved in the present application;

FIGS. 6A and 6B are sectional diagrams of the second embodiment of the piston in the diffuser system involved in the present application;

FIGS. 7A and 7B are sectional diagrams of the third embodiment of the piston in the diffuser system involved in the present application; and,

FIG. 8 is a diagram of another embodiment of the diffuser system involved in the present application.

### EMBODIMENTS

To help one skilled in the art exactly understand the subject claimed by the present application, the following is the elaboration made in combination with the figure about the embodiments of the present application.

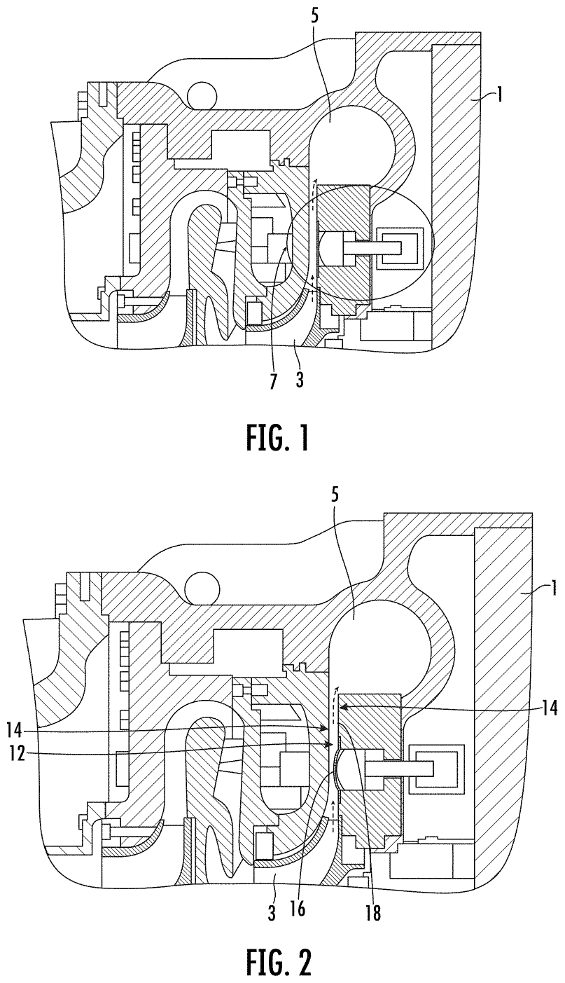

The diffuser system involved in the present application is intended for boosting the compressed fluid in compressors, especially in centrifugal compressors. The centrifugal compressors are widely employed in industries, and the objects of compression can be such as air or nitrogen gas, or such as liquid refrigerant used in refrigeration compressors. In the application of refrigeration compressors, ideally, liquid refrigerant and/or lubricating oil is not expected to enter the refrigeration compressor, but in reality, the compressor “suction with liquid” still occurs, so the “gas” mentioned in the present application in fact will entrain a small amount of liquid. Known from FIGS. 1-2, a compressor 1 comprises an impeller 3 and a volute 5 arranged on a radially outward side of the impeller 3. The diffuser system 7 is positioned between the impeller 3 and the volute 5. After departing from the impeller 3, a compressed gas will pass through the diffuser system 7 and then enter the volute 5. The dotted line with an arrow in the figures shows the flow route of the compressed gas. In the diffuser system 7, the compressed gas is boosted to convert kinetic energy to pressure energy, and further is boosted within the volute 5.

Known from the embodiment shown in the figures, the diffuser system 7 can regulate the passing flow of the compressed gas while boosting pressure of the compressed gas in a certain loaded work condition so as to increase the efficiency of compressors. One mode of implementation is that the diffuser blocks the passage where the compressed gas passes. FIG. 1 shows a work state of the compressor when the passage is fully open, i.e., the diffuser stops flow regulation; and, FIG. 2 shows a work state of the compressor when the passage is partially blocked, i.e., the diffuser carries out flow regulation. In the compressor, a passage 12 is an annular space defined by walls 14 of two sides (or called partitions). The wall 14 of one side (the wall 14 of the right in the figure) comprises a movable diffuser part 16 and a fixed diffuser part 18 (hereinafter “movable part 16” and “fixed part 18”). The movable part 16 moves in the passage 12, which can change the flow of the compressed gas. The movable part 16 is driven to translate towards the passage 12 and gradually blocks a portion of the passage 12 so as to reduce a flow area through which the compressed gas passes (i.e., the courses shown from FIG. 1 to FIG. 2). On the contrary, the movable part 16 moves in the opposite direction and gradually withdraws from the passage 12 so as to gradually enlarge the flow area through which the compressed gas passes (i.e., the courses shown from FIG. 2 to FIG. 1).

FIG. 3 is a partial enlargement of the involved diffuser system illustrated in FIG. 2. Referring to FIG. 3, the movable part 16 comprises an elastomer 24 and a piston 22. The elastomer 24 is a membrane element and is attached onto the wall. The membrane element can be made of rubber material or metal material, or the combination of these two materials. If rubber material is employed, the material of rubber can additionally have an elastic sheet adhering thereon, or can be modified—for example, fibre reinforced materials of high strength, to increase the strength of the membrane element. Alternatively, the membrane element can have a composite body with materials, the body having a core made of metal material and a wrap structure wrapping the core and made of rubber material. The membrane element can be made of hydrogenated nitrile butadiene rubber (HNBR), which has a fine elastic contractibility as well as a relative prolonged lifetime, and is compatible with a customized refrigerant. For example, but not limited to it, the membrane element can be made of Parker N1206 or Parker N1173 produced by Parker; or the membrane element can be made of Novapress850 produced by Frenzelit. The deformation of the elastomer 24 is caused by a movement of a piston 22. The piston 22 is further moved and driven by a drive system 26 at its back side. When the piston 22 moves forwards (see the hollow arrow shown in the figure), the elastomer 24 is pushed into the passage 12. At this moment, the elastomer 24 deforms to expand and make a compressed gas follow and pass its deformed expanding surface, as the dotted line shown in the figure. In the embodiment illustrated by the figure, the elastomer 24 deforms in the passage 12 to form a streamline front surface; and, the compressed gas passes along the surface. A surface shaped like this reduces the resistance against a flowing gas, thereby being able to increase the pneumatic performance and boosting efficiency. In this manner, the deformed elastomer 24 in the passage 12 can establish for a compressed gas an ideal pass route of the compressed gas. When the piston 22 moves in the opposite direction, the elastomer 24 will return to a flat state due to an elastic force after the elastomer 24 withdraws completely from the passage 12.

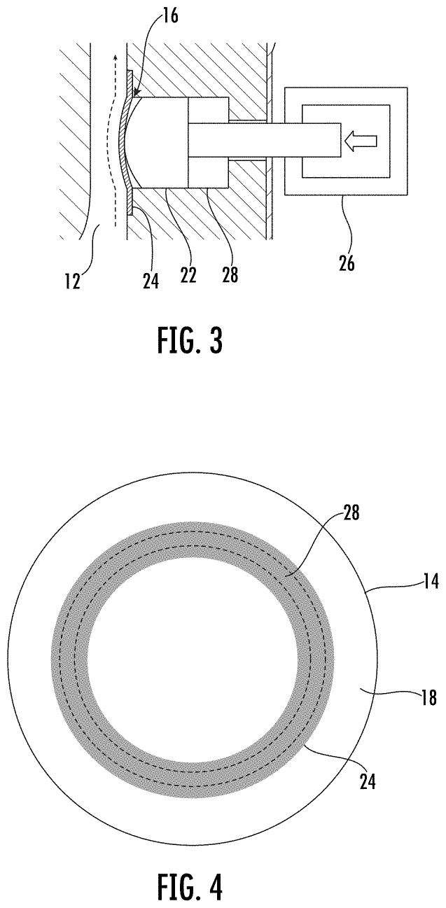

The piston 22 is received in a groove 28 of the wall. FIG. 4 illustrates at another angle the structure of this portion of the diffuser system. Known from the figure, the two circles formed by dotted lines define the groove 28 as an annular shape. Thus, the piston and the elastomer 24 received in the groove 28 are both of annular elements. The radial dimension of the elastomer 24 is slightly larger than that of the groove 28 so as to cover and seal the groove 28. An inner diameter edge part and an outer diameter edge part of the elastomer 24 are respectively attached onto the fixed part 18 of the wall 14. A middle part between the inner diameter edge and the outer diameter edge parts, i.e., an expanding part (the deformed shape shown in FIG. 3), can form a fine transition with the fixed part of the wall. As shall be understood, the elastomer 24 can be bonded onto the wall 14 by multiple known means or techniques.

The elastomer 24 can be driven by the piston 22 and the drive system 26 at the back side of the piston 22; for example, it can be driven directly by an existing drive system of a variable diffuser, or by other drive devices. As for the drive system 26, a pneumatic drive, a hydraulic drive (e.g., an oil hydraulic drive) or other known drive means can be employed. The elastomer 24 is driven to enter the passage and deforms, which re-orients the flow route of a compressed gas while changing the flow area of the compressed gas within the passage.

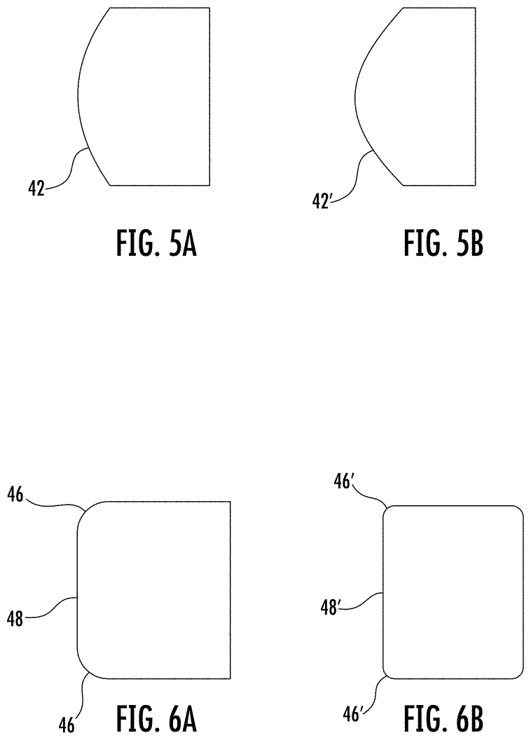

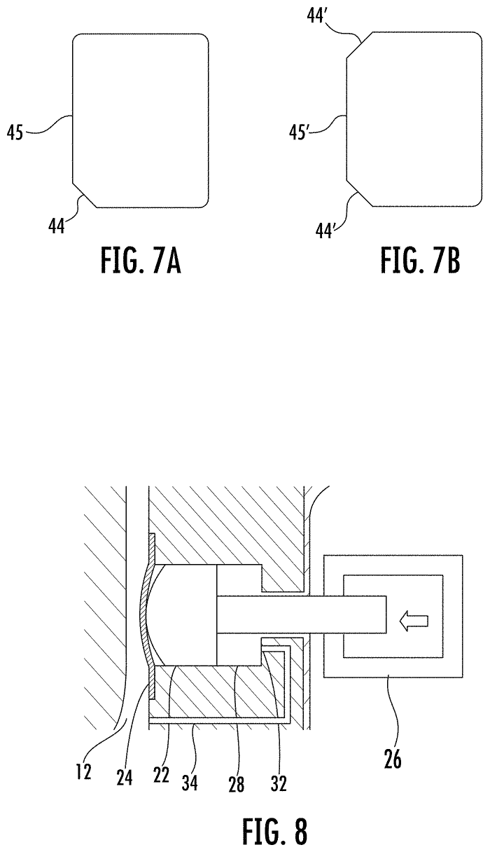

The movable part of the variable diffuser with a streamline shape established within the passage 12 will be helpful for flow of the compressed gas. The streamline shape can be enabled by modifying the back of the elastomer 24, i.e., the head of the piston. When the piston pushes the elastomer 24 into the passage 12, the head is in contact with the elastomer 24. Thus, a particular shape of the head can help the elastomer 24 to form an ideal shape. To enable the elastomer 24 to expand to be a streamline shape, the head of the piston 22 is designed to have an arc surface. FIGS. 5-7 show several shapes of the head of the piston 22 in the form of sections. The arc surface can be a symmetrical curve 42 shown in FIG. 5(a), which occupies the surface of the entire head of the piston; a curve 42′ of FIG. 5 (b) differs from FIG. 5 (a) in the radius of curvature—the radius of curvature of the curve 42′ is smaller than the curve 42. FIG. 6 (a) shows another arc surface, in which curves 46 are at the two ends connected by a beeline 48 that is straight. Certainly, an asymmetrical shape can also be allowed; that is, the curve 46 is arranged only at one end, e.g., at one end substantially facing a compressed gas. And, the curve 46 can be a round chamfer like the round chamfer with 45° arc shown in the figures, or be a round chamfer with different degree of arc. The surface illustrated by FIG. 6 (b) is also formed by connecting two curves 46′ with a beeline 48′, wherein the curves 46′ have a radius smaller than the curve 46 of FIG. 6 (a). FIG. 7 (a) further shows another arc surface, which comprises an oblique line 44 and a beeline 45 and wherein the oblique line 44 appears at the lower end, i.e., it faces a compressed gas. Further, the oblique line 44 is a flat chamfer, e.g., a flat chamfer with 45°, which is directly connected with the beeline 45 (as is illustrated in the figure) or smoothly and transitionally connected with the beeline 45. Here, the “arc surface” indicates that, after a piston with this shape acting on the elastomer 24, the elastomer 24 forms a shape with a streamline expanding surface. Depending on an elastic coefficient of the elastomer or a process of the elastomer bonded to the wall, the piston is driven to partially or fully contact with the elastomer. FIG. 7(a) shows an asymmetrical shape while FIG. 7(b) shows a symmetrical one, i.e., two oblique lines 44′ and a beeline 45′ connecting them. As shall be understood, the surface shape of a head of the piston is not limited to aforesaid examples, which may be other shapes that enable the elastomer 24 to deform to have a streamline surface.

FIG. 8 is a diagram of another embodiment of the diffuser system involved in the present application. The only difference lying between this embodiment and that illustrated by FIG. 3 is: a pressure balance hole 32 is provided at the bottom of the groove 28 and the pressure balance hole 32 is in communication with the passage 12 via a conduit 34. In the design of this type, the groove 28, due to the pressure balance hole 32, keeps a pressure the same as that of the passage 12, which helps the piston 22 to push the elastomer 24 into the passage 12; that is, it is not necessary for the drive system 26 to overcome an enormous resistance. In the embodiment illustrated by the figure, the pressure balance hole 32 is arranged at an end close to the impeller, i.e., the end substantially facing a compressed gas. One could think of that the pressure balance hole may also be arranged at an end close to the volute, i.e., the end substantially deviating from a compressed gas; and, at this end, the pressure of the compressed gas having been boosted will be larger to facilitate the drive system to output a drive force smoothly.

Although specific embodiments of the present application are already illustrated and elaborated to explain the principle of the present application, one shall understand that the present application may be implemented by other means but without a deviation from such a principle.

What is claimed is:

1. A diffuser system, comprising:
a passage through which a compressed gas is flowable;
a wall defining the passage, the wall comprising a movable part which is driven to enter the passage so as to change a flow area of the passage, wherein the movable part comprises an elastomer configured to expand to guide the flow of the compressed gas when at least a portion of the movable part enters the passage, and to retract when the movable part withdraws from the passage.

2. The diffuser system of claim 1, wherein the elastomer forms a streamline surface in the passage after expanding.

3. The diffuser system of claim 1, wherein the elastomer is a membrane element attached to the wall.

4. The diffuser system of claim 3, wherein the membrane element is made of rubber material or metal material, or wherein the membrane element comprises a core made of metal material and a wrap structure in which the core is contained, the wrap structure being made of rubber material.

5. The diffuser system of claim 4, wherein the membrane element is made of hydrogenated nitrile butadiene rubber.

6. The diffuser system of claim 1, wherein the movable part of the wall further comprises a piston for pushing the elastomer, the piston being arranged within a groove which forms on the wall and is sealed by the elastomer; the elastomer, the wall and the piston are configured to be annular.

7. The diffuser system of claim 6, wherein the piston is of a pneumatic drive, or is a hydraulic drive such as oil hydraulic drive.

8. The diffuser system of claim 7, wherein the piston has a rigid head in contact with the elastomer, the head having a section shape with an arc surface.

9. The diffuser system of claim 6, wherein a pressure balance hole is arranged at the bottom of the groove, the pressure balance hole being in communication with the passage.

10. A centrifugal compressor, comprising:
an impeller,
a volute arranged on a radially outward side of the impeller, and
the diffuser system of claim 1, wherein the passage is positioned between the impeller and the volute.
